(19) United States
(12) Patent Application Publication
(10) Pub. No.: US 2006/0086916 A1
(43) Pub. Date: Apr. 27, 2006

(54) Faucet security cap

(76) Inventor: Michael R. Falls, Gurnee, IL (US)

Correspondence Address: MICHAEL FALLS, 1023 MIDWAY ROAD, NORTHBROOK, IL, 60062, US

(21) Appl. No.: 10/971,804

(22) Filed: Oct. 22, 2004

(51) Int. Cl. F16K 35/00

(52) U.S. Cl. 251/91

(57) ABSTRACT

A cap (100) having threads (109) along a rim (107) of an opening (105) in an end of a body (101) screws on a faucet (300) having complementary threads (311) on which a packing nut can be installed. A cavity (103) inside the body (101) is capable of receiving and covering a valve stem (307) to prevent the unauthorized use of the faucet (300). A securing member, such as a screw (113) that passes through a hole (115) in the body (101), secures the cap (100) to the valve stem (307) to prevent removal of the cap (100) from the faucet (300).

### B. CROSS-REFERENCE TO RELATED APPLICATIONS

Not Applicable

### C. STATEMENT REGARDING FEDERALLY SPONSORED RESEARCH/DEVELOPMENT

The present invention does not involve any form of federally sponsored research or development.

### D. BACKGROUND OF THE INVENTION

The present invention relates to faucets, including, but not limited to, a cap that installs on threads of a faucet packing nut and prevents the unauthorized use of the faucet. Devices and methods for preventing the unauthorized use of faucets, particularly water faucets in common areas of multiple family housing and apartment complexes, are known. Typical water faucets include a handle that is connected to a valve stem and is used to control the flow of water from the faucet. Most residential buildings, single and multiple family dwellings, have several water faucets in easily accessible locations. For multiple family complexes the faucets are typically located in common areas and used to either water grass, shrubs, flowers, trees, and so forth or for general maintenance purposes such as hosing down walkway, parking lots, and so forth. Faucets can be located on the exterior of a building and in building interiors, such as in a common laundry area.

The owners and operators of multiple family complexes, such as rental apartment, and condominium associations pay for water, a utility cost, used in the common areas. Unauthorized and irresponsible water use can increase both utility, and maintenance costs. For example, the unauthorized use of water during hot weather in a sprinkler for recreational cooling of people increases water usage. In addition, continued unattended use of the sprinkler, for example accidentally leaving the sprinkler on all day and/or all night, could cause local flooding that results in damage requiring repair. The resulting costs ultimately increase rental costs. Further, higher rental cost caused by wasteful expenditure can create resident resentment, hostility, and/or divisiveness, particularly when trying to assign accountability of such expenditures on individuals at fault.

Restraints, such as protective caps, can provide protection against the unauthorized use of faucets. Unfortunately, determined individual can often find a way to remove the restraint and gain unauthorized access to the faucet. In addition, the restraints can be time consuming to install and remove when the faucet is used for an authorized purpose.

Accordingly, there is a need for a cap that deters unauthorized use of a faucet, yet the cap is easily removed from the faucet when the faucet is used for authorized purposes.

### E. BRIEF SUMMARY OF THE INVENTION

An apparatus includes at least one securing member that is mounted in a body having a cavity that is capable of accepting a faucet valve stem. The securing member is capable of engaging the faucet valve stem such that the apparatus can not be readily removed from the faucet and the unauthorized use of the faucet is deterred.

### F. BRIEF DESCRIPTION OF THE DRAWINGS

FIG. 1 illustrates a cross-section of a cap that can be securely attached to an end of a valve stem in accordance with the invention.

FIG. 2 illustrates a top view of a cap that can be securely installed by engaging a lateral surface of a valve stem in accordance with the invention.

FIG. 3 illustrates a cross-section of a cap installed on a faucet such that a ball bearing engages a groove in a valve stem in accordance with the invention.

FIG. 4 is a flowchart of a method for installing a cap on a faucet to prevent unauthorized use in accordance with the invention.

### G. DETAILED DESCRIPTION OF THE PREFERRED EMBODIMENT

The following describes an apparatus for and method of securely attaching a cap to a faucet so as to prevent the unauthorized use of the faucet. The cap includes at least one securing member that securely attaches the cap to the faucet by engaging the valve stem. The securing member securely attaches the cap the faucet by engaging a faucet valve stem.

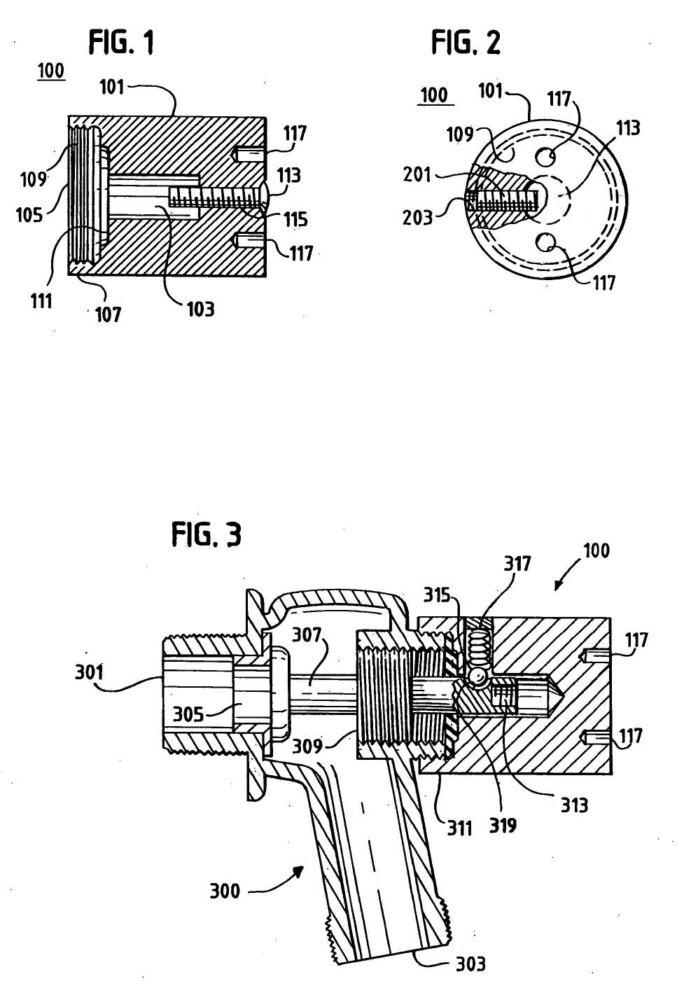

A cross-section of a cap 100 that can be securely attached to an end of a valve stem is shown in FIG. 1. The cap 100 includes a body 101 having a cavity 103 in communication with an opening 105. The cavity is capable of receiving a faucet valve stem (see FIG. 3) such that the valve stem is completely covered by the cap body when the cap is installed on a faucet. A rim 107 formed at the opening 103 has threads 109 and a flat surface 111. The threads complement packing nut threads (see FIG. 3) on a faucet, and the flat surface 111 is formed so that the flat surface 111 can engage and hold a faucet packing (see FIG. 3) in place. A screw 113, a securing member that is capable of engaging the threads (see FIG. 3) at the end of a faucet valve stem, is mounted inside a hole 115 in the body 101. Preferably, the hole is not threaded so that the screw can rotate freely in the hole. A head of the screw can be designed to form an approximately flush surface with the outer surface of the cap body 101. To deter the removal, the cap 100 has bores 117 that are capable of accepting pin of a spanner tool that can be used to install or remove the cap 100 from the faucet. Similarly as a deterrent to cap removal, the head of the screw 113 can be design so that a special tool is required for the removal of the screw.

A top view of the cap 100 that can be securely installed by engaging a lateral surface of a valve stem is shown in FIG. 2. In this embodiment, the securing member is a set screw 201 that securely engages the lateral surface (not shown) of the valve stem. The set screw 201 is mounted in a threaded hole 203 in the body 101. An end of the set screw 201 extends into the cavity 103 so as to engage the lateral edge (not shown) of the valve stem to securely hold the cap 100 on the faucet. The valve stem is generally a cylindrical shape such that the lateral surface has a curved shape. Alternatively, the valve stem can be formed to have a flat surface that extends laterally along the valve stem such that a cross-section of the valve stem forms a chord that connects the two ends of an arc that is greater than one hundred eighty degrees.

A cross-section of a cap 100 installed on a faucet 300 such that a ball bearing 315 engages a groove 319 in a valve stem 307 is as shown in FIG. 3. The faucet 300, as commonly known in the art, includes an inlet 301, outlet 303, and a plug 305 that is operably connected to a valve stem 307. A packing 309 provides a leak resistant seal for the valve stem 307. Typically, the packing 307 is held in place with a packing nut (not shown) mounted on threads 311. In addition, a handle (not shown) for operating the faucet 300 is normally mounted at the end of the valve stem with a screw that engages the threaded bore 313 in the end of the valve stem. With the faucet handle and the packing nut removed the cap 100 is screwed on the threads 311 for the packing nut.

In this embodiment, the securing member includes a ball bearing 315 and a spring mechanism 317. The ball bearing 315 engages a bore 319 in the valve stem 307 such that the cap 100 can not be removed from the valve stem unless the ball bearing 315 is removed from the bore 319. Alternatively, the valve stem can have a groove for engaging the ball bearing that extends circumferentially around the outer surface of the valve stem. As known in the art, the spring mechanism 315 is rotatably mounted in the body 101 such that a tool can be used to manipulate the spring mechanism so that the ball bearing 315 can be movably engaged with and movably retracted from the bore 319. Preferably, the spring mechanism is formed so that a special tool is required to operate the spring mechanism. Alternatively, a cylindrical pin, other geometrically shaped members, mechanical keys, other mechanical locking devices and so forth, can be used instead of a ball bearing.

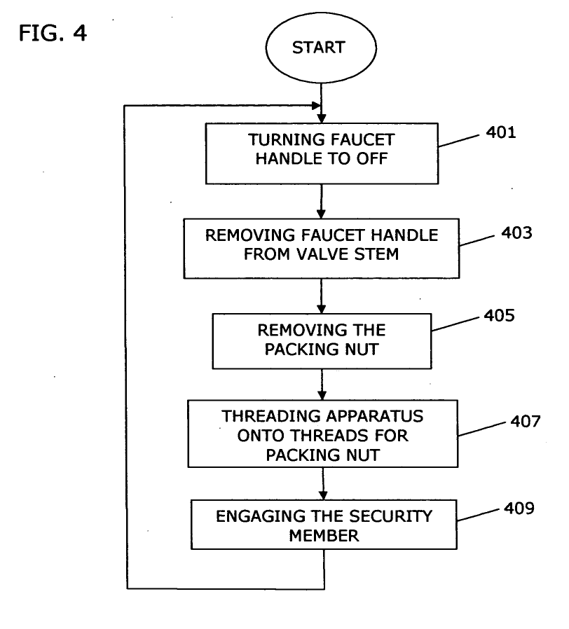

A flowchart of a method for installing a cap on a faucet to prevent unauthorized use is shown in FIG. 4. At step 401, the faucet 300 is shut off by turning a handle (not shown) to the closed position. In the closed position, the plug 305 blocks water flow from the faucet such that there typically is minimal fluid pressure on the packing 309. At step 403, the faucet handle (not shown) is removed from the valve stem 307. Typically, the handle is attached with a screw the fits into the threaded bore 313 at the end of the valve stem 307 such that the handle can be removed by simply removing the screw. At step 407, the packing nut (not shown) is removed such that the threads 311 become available to receive the cap 100. At step 409, the cap 100 is threaded onto the threads 311. Preferably, a special spanner that engages bores 117 is used to install the cap 100, which is typically cylindrical in shape and has smooth outer surfaces. At step 409, a securing member engages the faucet valve stem 307. For example, the securing member can be a screw 113 that is screwed into the threaded bore 313 at the end of the valve stem 307. Alternatively, the securing member can be the set screw 201 or the ball bearing 315 and spring mechanism 317 that engage the valve stem 307. In addition, to using a securing member, heat release adhesive can be used on the threads 311 so that heat must be applied to remove the cap 100 from the faucet 300.

Although the present invention is illustrated by the example of a faucet having a horizontal valve stem, an downward directed outlet, and male threads to which the packing nut screws onto, the present invention may be applied to different faucet design, sizes, and shapes including those with female threads for receiving the packing nut. The different faucet designs may give rise to different cap sizes or even designs; however, the cap would still be mounted on the packing nut and would have a body that covered the valve stem so as to preclude unauthorized used of the faucet. For example, a faucet having female threads for accepting the packing nut with male threads would have a cap that has male threads on the outside surface of the rim at the opening in the body.

Further, the present invention is illustrated by the example of a securing member mounted in the cap that engages the valve stem; however, the present invention may be applied to securing members mounted in the cap that engage the valve body. For example, the securing member can be a set screw that is mounted in the cap body and engages either the faucet housing or the threads on which the packing nut attaches.

The present invention provides a number of advantages, including the ability to securely attach a cap on a faucet that prevents the unauthorized use of the faucet. Securely attaching the cap to the faucet reduces the potential of the cap being removed and the faucet being used for unauthorized purposes. The present invention provides for the use of a special tool such as a spanner for the removal and installation of the cap and the securing member. The special tools can provide an additional deterrent to the potential removal of the cap and unauthorized use of the faucet, yet the cap can be easily removed for authorized use of the faucet. In addition, smooth surfaces of the cap that are difficult to grasp tightly or the use of heat release adhesive for cap installation provide additional measures to prevent the unauthorized use of the faucet. The present invention reduces utility costs for single or multiple family housing by reducing the unauthorized uses of water faucets. For multiple family housing units, controlling unauthorized use of faucets in common areas can help to reduce rental rates or reduce time spent in trying to assign the costs to specific renters.

The present invention may be embodied in other specific forms without departing from its spirit or essential characteristics. The described embodiments are to be considered in all respects only as-illustrative and not restrictive. The scope of the invention is, therefore, indicated by the appended claims rather than by the foregoing description. All changes that come within the meaning and range of equivalency of the claims are to be embraced within their scope.

What is claimed is:

1. An apparatus comprising:
a body having an end with an opening;
a rim of the opening, wherein the rim has threads that cooperate with packing nut threads of a faucet, and a surface that is capable of engaging a packing of the faucet;
a cavity in communication with the opening, wherein the cavity is capable of accepting a faucet valve stem; and
at least one securing member, wherein the securing member is capable of securing the apparatus to a component of the faucet.

2. The apparatus of claim 1, wherein the component is a valve stem of the faucet.

3. The apparatus of claim 1, wherein the component is a housing of the faucet.

4. The apparatus of claim 1, wherein the securing member includes a ball bearing operably connected to a compression device such that the ball bearing is capable of engaging a groove in the component of the faucet valve.

5. The apparatus of claim 4, wherein the compression device includes a spring.

6. The apparatus of claim 1, wherein the securing member is a screw that passes through a hole in the body of the apparatus and is capable of engaging a component of the faucet.

7. The apparatus of claim 6, wherein the hole is disposed adjacent to an end of the faucet valve stem when the apparatus is installed on the faucet, and the screw cooperates with a threaded bore in an end of a faucet valve stem.

8. The apparatus of claim 6, wherein the hole is disposed adjacent to a lateral side of the faucet valve stem when the apparatus is installed on the faucet wherein the screw is capable of engaging a surface of the lateral side of the faucet valve stem.

9. The apparatus of claim 1, wherein the body is approximately a cylinder having a smooth curved surface that limits traction when grasped wherein the smooth curved surface acts as a deterrent to removal of the apparatus.

10. The apparatus of claim 1, further comprising at least one bore in the apparatus wherein the bore is capable of engaging a spanner designed to install and remove the apparatus.

11. An apparatus comprising:
a generally cylindrical body having a smooth curved surface, a first end having a flat surface, and a second end having an opening;
a rim of the opening, wherein the rim has threads that are capable of cooperating with packing nut threads of a faucet, and a surface that is capable of engaging a packing of the faucet;
a cavity in communication with the opening, wherein the cavity is capable of accepting a valve stem of the faucet; and
at least one securing member mounted in the body, wherein the securing member is capable of securing the apparatus to a valve stem of the faucet.

12. The apparatus of claim 11, wherein the securing member includes a ball bearing operably connected to a compression device wherein the ball bearing is capable of engaging a groove in the faucet valve stem.

13. The apparatus of claim 12, wherein the compression device includes a spring.

14. The apparatus of claim 11, wherein the securing member is a screw that passes through a hole in the body of the apparatus and is capable of engaging the faucet valve stem.

15. The apparatus of claim 14, wherein the hole is disposed adjacent to an end of the faucet valve stem when the apparatus is installed on the faucet, and the screw cooperates with a threaded bore in an end of the faucet valve stem.

16. The apparatus of claim 14, wherein the hole is disposed adjacent to a lateral side of the faucet valve stem when the apparatus is installed on the faucet wherein the screw is capable of engaging a surface of the lateral side of the faucet valve stem.

17. The apparatus of claim 1 1, further comprising at least one bore in the apparatus wherein the bore is capable of engaging a spanner designed to install and remove the apparatus.

18. The apparatus of claim 9, wherein the smooth curved surface limits traction when grasped wherein the smooth curved surface acts as a deterrent to removal of the apparatus.

19. A method comprising the steps of:
turning a handle attached to a valve stem of a faucet to a closed position such that liquid flow from the faucet is minimized;
removing the handle from the valve stem;
removing a packing nut from threads on a housing of the faucet wherein the packing nut secures a packing that surround the valve stem;
threading an apparatus onto threads on the housing for the packing nut; and
engaging a securing member with a component of the faucet.

20. The method of claim 19, further comprising the step of applying a heat release adhesive to the threads on the housing of the faucet.

21. The method of claim 20, wherein the component is a valve stem.

22. The method of claim 20, wherein the component is the housing of the faucet.
